(19) United States
(12) Patent Application Publication
(10) Pub. No.: US 2016/0032735 A1
(43) Pub. Date: Feb. 4, 2016

(54) TRANSIENT LIQUID PHASE BONDED TIP SHROUD

(71) Applicant: UNITED TECHNOLOGIES CORPORATION, Hartford, CT (US)

(72) Inventors: Michael G. McCaffrey, Windsor, CT (US); Michael G. Abbott, Jupiter, FL (US); Grant O. Cook, III, Spring, TX (US)

(73) Assignee: United Technologies Corporation, Hartford, CT (US)

(21) Appl. No.: 14/775,535

(22) PCT Filed: Mar. 11, 2014
(86) PCT No.: PCT/US14/23082

§ 371 Date: Sep. 11, 2015

Related U.S. Application Data
(60) Provisional application No. 61/787,130, filed on Mar. 15, 2013.

(51) Int. Cl. F01D 5/28; F01D 5/14

(52) U.S. Cl. CPC F01D 5/284; F01D 5/282; F01D 5/147; F05D 2300/6033

(57) ABSTRACT

A composite ceramic turbine blade includes a ceramic airfoil portion and a ceramic outer tip shroud portion. The ceramic outer tip shroud portion is joined to the ceramic airfoil portion by a bonding means. In an embodiment, the bonding means comprises partial transient liquid phase bonding. In another embodiment, the airfoil portion is a fiber reinforced ceramic.

### BACKGROUND

This invention relates to a turbine blade having a tip shroud. In particular, the invention relates to joining a ceramic tip shroud to a ceramic turbine blade.

The efficiency of a gas turbine engine depends on many factors. The temperature difference between the inlet and exhaust gasses needs to be maintained as high as possible. Air leakage around the tips of turbine blades in the hot gas path of the turbine engine is a detriment to overall efficiency. Tip shrouds on turbine blades decrease gas leakage by maintaining dimensional clearance between the blade tip and outer casing of the gas path by mechanically supporting the blade tips and by damping unnecessary vibration. The centrifugal stress on a tip shroud can be excessive and can distort the blade as well as the shroud itself. Although lower density ceramic components experience lower centrifugal forces, interior shear loading during operation can be an issue in the ceramic materials.

### SUMMARY

A composite ceramic turbine blade comprises a ceramic airfoil portion joined to a ceramic outer tip shroud portion. In an embodiment, the outer tip shroud portion and the ceramic airfoil portion are joined by partial transient liquid phase bonding.

A method of forming a ceramic turbine blade including a ceramic airfoil portion joined to a ceramic outer tip shroud portion by partial transient liquid phase bonding includes applying a bonding material to the tip of the airfoil portion and inserting the tip into a cavity in the ceramic tip shroud. Heating the airfoil and tip shroud causes the bonding material to melt, wet the airfoil and tip shroud, and isothermally solidify to form a solid bond.

### BRIEF DESCRIPTION OF THE DRAWINGS

FIG. 1 is an isometric view of a ceramic tip shroud joined to a fiber reinforced ceramic airfoil.

FIG. 2A is the AA cross section of FIG. 1.

FIG. 2B is a detail of the joint under a shear stress.

FIG. 3A is a cross section of a prior art monolithic ceramic fiber reinforced airfoil and tip shroud.

FIG. 3B shows an enlarged view of a region C under a shear stress.

### DETAILED DESCRIPTION

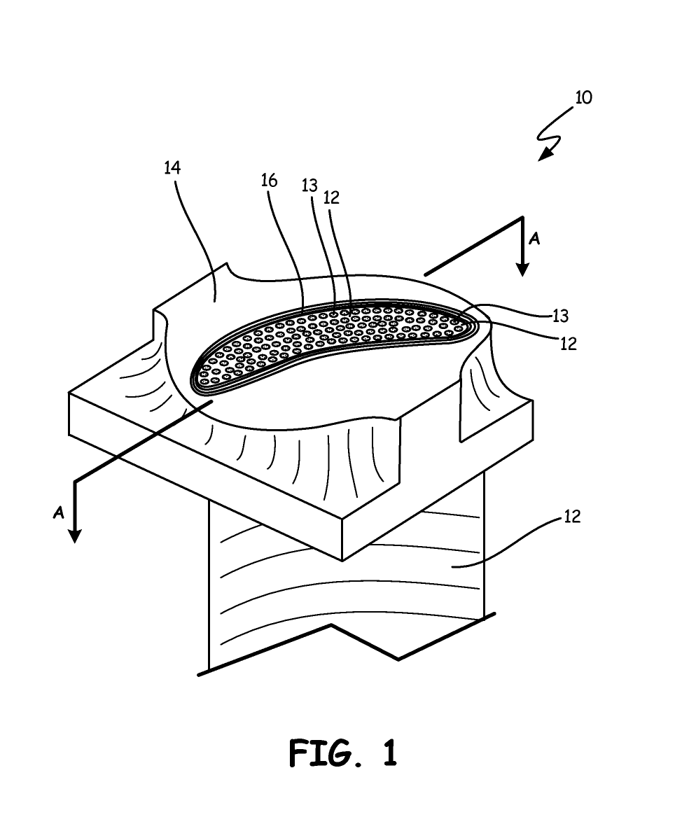

An isometric view of composite airfoil and tip shroud assembly 10 of the invention is shown in FIG. 1. Airfoil 12 is shown attached to monolithic ceramic tip shroud 14 by bonding material 16 between airfoil 12 and tip shroud 14. A major feature of the invention is the method of joining airfoil 12 to ceramic tip shroud 14. This method is illustrated in FIG. 1, wherein airfoil 12 is inserted through a cavity in ceramic tip shroud 14 and is joined to ceramic tip shroud 14 by bonding material 16 at the interface between the two components. As will be discussed, this joining method significantly decreases detrimental internal centrifugal shear loading in ceramic tip shroud 14 during operation.

Although not limited by any single method, monolithic ceramic tip shroud 14 of this invention may be formed by casting, pressing and sintering, hot pressing, hot isostatically pressing, and by other methods known in the art. Ceramic tip shroud 14 may be any ceramic and may be preferably a non-oxide ceramic and more preferably silicon carbide or silicon nitride. Ceramic airfoil 12 may also be any ceramic but preferably a non-oxide ceramic. Airfoil 12 may also be a fiber reinforced ceramic to withstand the operating stresses in a gas turbine engine. Airfoil 12 may be a fiber reinforced ceramic matrix composite (CMC), preferably a non-oxide fiber reinforced CMC. In an embodiment, airfoil 12 may be silicon carbide fiber reinforced silicon carbide (SiC/SiC). In another embodiment, airfoil 12 may be silicon carbide fiber reinforced silicon nitrogen carbide (SiC/SiNC).

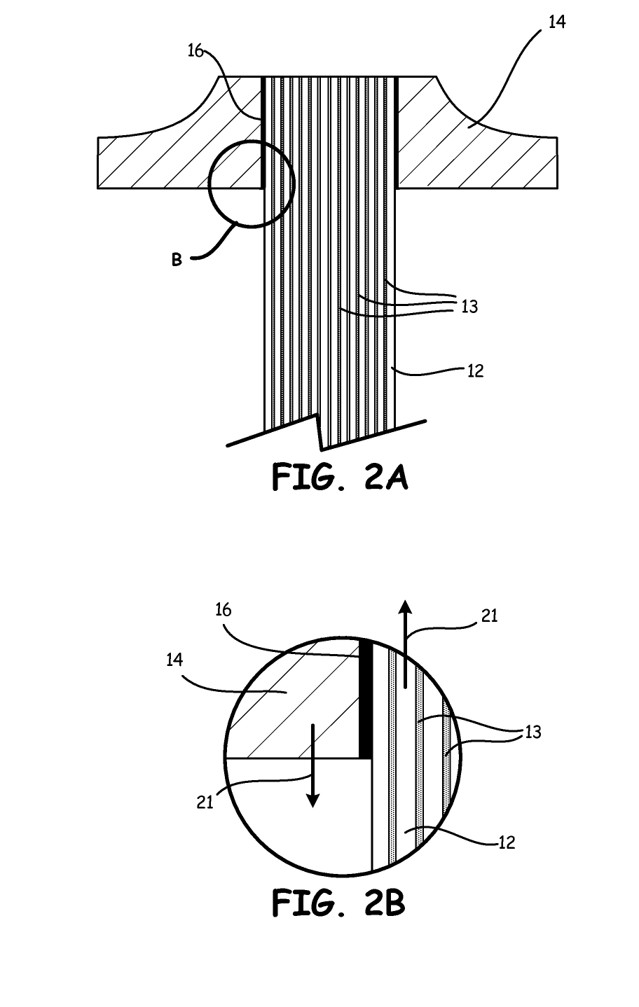

Cross section AA of airfoil/tip shroud assembly 10 of the invention is shown in FIG. 2A. Fiber reinforced ceramic airfoil 12 containing fibers 13 is shown inserted in ceramic tip shroud 14. Bonding material 16 is shown bonding the two components together. An enlarged view of region B at the intersection of the bottom corner of component 14 where it meets airfoil 12 is shown in FIG. 2B. Note that under the shear stress loading during operation as indicated by shear load arrows 21, all loading is parallel to fibers 13 and no fiber fracture is anticipated. The strength of the joint in that region depends completely on the strength of bond material 16.

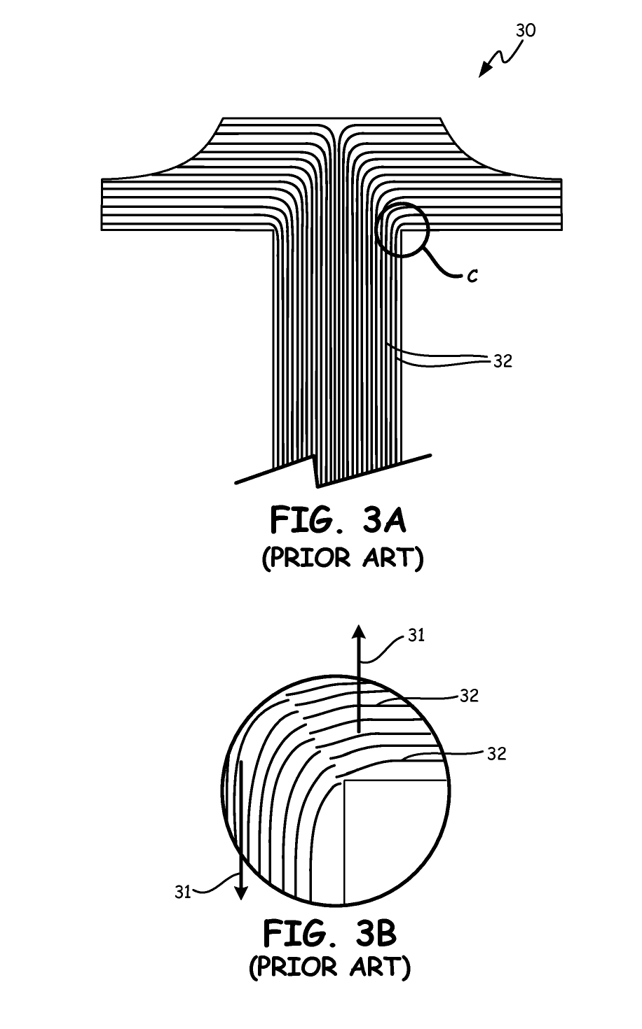

Monolithic prior art airfoil/tip shroud structures have disadvantages as shown in FIG. 3A. FIG. 3A is a schematic cross section of fiber reinforced ceramic matrix composite structure 30, wherein the ceramic tip shroud and airfoil are fabricated in one piece. FIG. 3B shows a situation in the vicinity of region C, where the monolithic material is under an internal shear stress, as indicated by the shear load vectors 31. In this case, it is clear, in contrast to the structure of the invention shown in FIG. 2B, fibers 32 may fracture under the local shear load in the vicinity of region C.

Bonding material 16 of the invention is a material that results in a solid bond by the process of partial transient liquid phase bonding (PTLB). Transient liquid phase (TLP) and partial transient liquid phase (PTLP) bonding are described in detail in “Overview of Transient Liquid Phase and Partial Transient Liquid Phase Bonding”, J. Mater. Sci. (2011) 46: 5305-5323 by one of the inventors and is incorporated herein in its entirety. In PTLB of the invention, bonding material 16 may be a multilayer structure comprising thin layers of low melting point metals or alloys placed on each side of a much thicker layer of a refractory metal or alloy core. Upon heating to a bonding temperature, a liquid is formed via either direct melting of a lower-melting layer or a eutectic reaction of a lower-melting layer with the refractory metal layer. The liquid that is formed wets each ceramic substrate, while also diffusing into the refractory metal core. During the process, the liquid regions solidify isothermally and homogenization of the entire bond region leads to a solid refractory bond.

Example bond alloy layers (separated by pipe characters) for bonding silicon carbide to silicon carbide fiber reinforced silicon carbide (SiC/Sic) or to silicon carbide fiber reinforced silicon nitrogen carbide (SiC/SiNC) are C|Si|C, Cu—Au—Ti|Ni|Cu—Au—Ti, and Ni—Si|Mo|Ni—Si multilayer metal structures.

Example bond alloy layers for bonding silicon nitride to silicon carbide fiber reinforced silicon carbide (SiC/SiC) or silicon carbide fiber reinforced silicon nitrogen carbide (SiC/SiNC) are Al|Ti|Al, Au|Ni—Cr|Au, Cu—Au|Ni|Cu—Au, Co|Nb|Co, Co|Ta|Co, Co|Ti|Co, Co|V|Co, Cu—Ti|Pd|Cu—Ti, and Ni|V|Ni multilayer metal structures.

Additional example bond alloy layers include non-symmetric multilayer metal structures, such as Cu—Au—Ti|Ni|Cu—Au, Au|Ni—Cr|Cu—Au, Au|Ni—Cr|Cu—Au—Ti, and Al|Ti|Co. These non-symmetric structures can accommodate for differences in wetting characteristics between the ceramic material and the CMC material.

### DISCUSSION OF POSSIBLE EMBODIMENTS

The following are non-exclusive descriptions of possible embodiments of the present invention.

A composite ceramic turbine blade may include a ceramic airfoil portion and a ceramic outer tip shroud portion joined to the airfoil portion.

The turbine blade of the preceding paragraph can optionally include, additionally, and/or alternatively, any, one or more of the following features, configurations, and/or additional components:

The ceramic airfoil may be a fiber reinforced ceramic.

The fiber reinforced ceramic may be silicon carbide fiber reinforced silicon carbide (SiC/SiC) or silicon carbide fiber reinforced silicon nitrogen carbide (SiC/SiNC).

The outer tip shroud portion may comprise a bulk cast, sintered, or hot pressed ceramic.

The ceramic may comprise silicon carbide or silicon nitride.

The ceramic airfoil portion may be joined to the outer tip portion by a bonding material.

The bonding material may cause joining by partial liquid phase bonding.

The bonding material for joining silicon carbide fiber reinforced silicon carbide (SiC/SiC) or silicon carbide fiber reinforced silicon nitrogen carbide (SiC/SiNC) to silicon carbide may comprise C|Si|C, Cu—Au—Ti|Ni|Cu—Au—Ti, and Ni—Si|Mo|Ni—Si multilayer metal structures.

The bonding material for joining silicon carbide fiber reinforced silicon carbide (SiC/SiC) or silicon carbide fiber reinforced silicon nitrogen carbide (SiC/SiNC) to silicon nitride may comprise Al|Ti|Al, Au|Ni—Cr|Au, Cu—Au|Ni|Cu—Au, Co|Nb|Co, Co|Ta|Co, Co|Ti|Co, Co|V|Co, Cu—Ti|Pd|Cu—Ti, and Ni|V|Ni multilayer metal structures.

The bonding material for joining silicon carbide reinforced silicon carbide (SiC/SiC) or silicon carbide fiber reinforced silicon nitrogen carbide (SiC/SiNC) to silicon nitride or silicon carbide may comprise Cu—Au—Ti|Ni|Cu—Au, Au|Ni—Cr|Cu—Au, Au|Ni—Cr|Cu—Au—Ti, and Al|Ti|Co multilayer metal structures.

The partial transient liquid phase bonding may comprise heating the airfoil and tip shroud to a bonding temperature at which the multilayer bonding material melts, wets the ceramics, and isothermally solidifies forming a solid bond.

A method of forming a composite ceramic turbine blade comprising a ceramic airfoil portion joined to a ceramic outer tip shroud by partial transient liquid phase bonding may comprise applying a bonding material to the tip of the ceramic airfoil; inserting the tip of the ceramic airfoil into a cavity in the ceramic tip shroud; heating the airfoil and ceramic tip shroud such that the bonding material melts, wets the airfoil and tip shroud, and isothermally solidifies forming a solid bond.

The method of the preceding paragraph can optionally include, additionally, and/or alternatively, any, one or more of the following features, configurations, and/or additional components:

The ceramic airfoil may be a fiber reinforced ceramic.

The fiber reinforced ceramic may be silicon carbide fiber reinforced silicon carbide (SiC/SiC) or silicon carbide fiber reinforced silicon nitrogen carbide (SiC/SiNC).

The ceramic outer tip shroud may comprise a bulk cast, sintered, or hot pressed ceramic.

The ceramic may be silicon carbide or silicon nitride.

The airfoil may comprise silicon carbide fiber reinforced silicon carbide (SiC/SiC) or silicon carbide fiber reinforced silicon nitrogen carbide (SiC/SiNC).

The ceramic may be silicon carbide and bonding material may be C|Si|C, Cu—Au—Ti|Ni|Cu—Au—Ti, and Ni—Si|Mo|Ni—Si multilayer metal structures.

The ceramic may be silicon nitride and bonding material may be Al|Ti|Al, Au|Ni—Cr|Au, Cu—Au|Ni|Cu—Au, Co|Nb|Co, Co|Ta|Co, Co|Ti|Co, Co|V|Co, Cu—Ti|Pd|Cu—Ti, and Ni|V|Ni multilayer metal structures.

The ceramic may be silicon carbide or silicon nitride and bonding material may be Cu—Au—Ti|Ni|Cu—Au, Au|Ni—Cr|Cu—Au, Au|Ni—Cr|Cu—Au—Ti, and Al|Ti|Co multilayer metal structures.

Although the present invention has been described with reference to preferred embodiments, workers skilled in the art will recognize that changes may be made in form and detail without departing from the spirit and scope of the invention.

1. A composite ceramic turbine blade comprising:
a ceramic airfoil portion; and
a ceramic outer tip shroud portion joined to the airfoil portion.

2. The turbine blade of claim 1, wherein the ceramic airfoil is a fiber reinforced ceramic.

3. The turbine blade of claim 2, wherein the fiber reinforced ceramic is silicon carbide fiber reinforced silicon carbide (SiC/SiC) or silicon carbide fiber reinforced silicon nitrogen carbide (SiC/SiNC).

4. The turbine blade of claim 1, wherein outer tip shroud portion comprises a bulk cast, sintered, or hot pressed ceramic.

5. The turbine blade of claim 4, wherein ceramic comprises silicon carbide or silicon nitride.

6. The turbine blade of claim 1, wherein the ceramic airfoil portion is joined to the outer tip shroud portion with a bonding material.

7. The turbine blade of claim 6, wherein the bonding material causes joining by partial transient liquid phase bonding.

8. The turbine blade of claim 7, wherein the bonding material for joining silicon carbide fiber reinforced silicon carbide (SiC/SiC) or silicon carbide fiber reinforced silicon nitrogen carbide (SiC/SiNC) to silicon carbide is selected from the group consisting of C|Si|C, Cu—Au—Ti|Ni|Cu—Au—Ti, and Ni—Si|Mo|Ni—Si multilayer metal structures.

9. The turbine blade of claim 7, wherein the bonding material for joining silicon carbide fiber reinforced silicon carbide (SiC/SiC) or silicon carbide fiber reinforced silicon nitrogen carbide (SiC/SiNC) to silicon nitride is selected from the group consisting of Al|Ti|Al, Au|Ni—Cr|Au, Cu—Au|Ni|Cu—Au, Co|Nb|Co, Co|Ta|Co, Co|Ti|Co, Co|V|Co, Cu—Ti|Pd|Cu—Ti, Ni|V|Ni multilayer metal structures.

10. The turbine blade of claim 7, wherein the bonding material for joining silicon carbide fiber reinforced silicon carbide (SiC/SiC) or silicon carbide fiber reinforced silicon nitrogen carbide (SiC/SiNC) to silicon nitride or silicon carbide is selected from the group consisting of Cu—Au—Ti|Ni|Cu—Au, Au|Ni—Cr|Cu—Au, Au|Ni—Cr|Cu—Au—Ti, and Al|Ti|Co multilayer metal structures.

11. The turbine blade of claim 7, wherein partial transient liquid phase bonding comprises heating the airfoil, bonding material, and tip shroud to a bonding temperature at which the multilayer bonding material melts, wets the ceramics, and isothermally solidifies forming a solid bond.

12. A method of forming a composite ceramic turbine blade comprising a ceramic airfoil portion joined to a ceramic outer tip shroud by partial transient liquid phase bonding comprises:
applying a bonding material to the tip of the ceramic airfoil;
inserting the tip of the ceramic airfoil into a cavity in the ceramic tip shroud;
heating the airfoil and ceramic tip shroud such that the bonding material melts, wets the airfoil and tip shroud, and isothermally solidifies forming a solid bond.

13. The method of claim 12, wherein the ceramic airfoil is a fiber reinforced ceramic.

14. The method of claim 12, wherein the fiber reinforced ceramic is silicon carbide fiber reinforced silicon carbide (SiC/SiC) or silicon carbide fiber reinforced silicon nitrogen carbide (SiC/SiNC).

15. The method of claim 12, wherein ceramic outer tip shroud comprises a bulk cast, sintered, or hot pressed ceramic.

16. The method of claim 15, wherein the ceramic is silicon carbide or silicon nitride.

17. The method of claim 12, wherein airfoil comprises silicon carbide fiber reinforced silicon carbide (SiC/SiC) or silicon carbide fiber reinforced silicon nitrogen carbide (SiC/SiNC).

18. The method of claim 17, wherein the ceramic is silicon carbide and the bonding material is selected from the group consisting of C|Si|C, Cu—Au—Ti|Ni|Cu—Au—Ti, and Ni—Si|Mo|Ni—Si multilayer metal structures.

19. The method of claim 17, wherein the ceramic is silicon nitride and the bonding material is selected from the group consisting of Al|Ti|Al, Au|Ni—Cr|Au, Cu—Au|Ni|Cu—Au, Co|Nb|Co, Co|Ta|Co, Co|Ti|Co, Co|V|Co, Cu—Ti|Pd|Cu—Ti, and Ni|V|Ni multilayer metal structures.

20. The method of claim 17, wherein the ceramic is silicon carbide or silicon nitride and the bonding material is selected from the group consisting of Cu—Au—Ti|Ni|Cu—Au, Au|Ni—Cr|Cu—Au, Au|Ni—Cr|Cu—Au—Ti, and Al|Ti|Co multilayer metal structures.
